(19) United States
(12) Patent Application Publication
(10) Pub. No.: US 2021/0218029 A1
(43) Pub. Date: Jul. 15, 2021

(54) NEGATIVE ELECTRODE AND LITHIUM SECONDARY BATTERY INCLUDING NEGATIVE ELECTRODE

(71) Applicant: LG CHEM, LTD., Seoul (KR)

(72) Inventors: Jun Hyuk SONG, Daejeon (KR); Je Young KIM, Daejeon (KR); Joo Sung LEE, Daejeon (KR); Suk In NOH, Daejeon (KR); Hee Won LEE, Daejeon (KR)

(73) Assignee: LG CHEM, LTD., Seoul (KR)

(21) Appl. No.: 17/054,423

(22) PCT Filed: May 9, 2019
(86) PCT No.: PCT/KR2019/005580

§ 371 Date: Nov. 10, 2020

(30) Foreign Application Priority Data
May 15, 2018 (KR) 10-2018-0055516

(51) Int. Cl. H01M 4/62; H01M 10/0525; H01M 4/131; H01M 4/485; H01M 4/66

(52) U.S. Cl. CPC H01M 4/621; H01M 10/0525; H01M 2004/027; H01M 4/485; H01M 4/661; H01M 4/131

(57) ABSTRACT

A negative electrode and a secondary battery including the same are described, the negative electrode including a current collector and a negative electrode active material layer disposed on the current collector, wherein the negative electrode active material layer includes a negative electrode active material including SiOₓ (0≤x<2) particles, a conductive material, and a binder, and the negative electrode active material layer includes a lower layer in contact with the current collector, an upper layer positioned on the lower layer, and an intermediate layer positioned between the lower layer and the upper layer.

### CROSS-REFERENCE TO RELATED APPLICATIONS

This application claims the benefit of Korean Patent Application No. 10-2018-0055516, filed on May 15, 2018, in the Korean Intellectual Property Office, the disclosure of which is incorporated herein in its entirety by reference.

### TECHNICAL FIELD

### Technical Field

The present invention relates to a negative electrode and a secondary battery including the same, the negative electrode including a current collector and a negative electrode active material layer disposed on the current collector, wherein the negative electrode active material layer includes a negative electrode active material including SiOₓ (0≤x<2) particles, a conductive material, and a binder, and the negative electrode active material layer includes a lower layer in contact with the current collector, an upper layer positioned on the lower layer, and an intermediate layer positioned between the lower layer and the upper layer, and the total content of the conductive material and the binder in the upper layer is greater than the total content of the conductive material and the binder in the intermediate layer, and the total content of the conductive material and the binder in the lower layer is less than the total content of the conductive material and the binder in the intermediate layer.

### Background Art

Demands for the use of alternative energy or clean energy are increasing due to the rapid increase in the use of fossil fuel, and as a part of this trend, the most actively studied field is a field of electricity generation and electricity storage using an electrochemical reaction.

Currently, a typical example of an electrochemical device using such electrochemical energy is a secondary battery and the usage areas thereof are increasing more and more. In recent years, as technology development of and demand for portable devices such as portable computers, mobile phones, and cameras have increased, demands for secondary batteries as an energy source have been significantly increased. Among such secondary batteries, lithium secondary batteries having high energy density, that is lithium secondary batteries having high capacity, have been subjected to considerable research and also have been commercialized and widely used.

In general, a secondary battery is composed of a positive electrode, a negative electrode, an electrolyte, and a separator. Among the above, the negative electrode includes a negative electrode current collector and a negative electrode active material, and may include a negative electrode active material layer disposed on the negative electrode current collector.

Meanwhile, in order to increase the energy density of the negative electrode, various negative electrode active materials such as silicon is used. However, silicon expands excessively in volume during charge and discharge, thereby causing electrical short circuits between negative electrode active materials, and the structure of the negative electrode active material itself is destroyed. Furthermore, in the case in which the negative electrode discharge potential in the secondary battery becomes higher than 0.5 V, the structure of the silicon in the negative electrode in which lithium is intercalated is changed into a structure (phase separation) in which two separated phases of Li₁₂Si₇ and Si exist. Accordingly, excessive stress is generated at the interface of the two phases so that the pulverization of the negative electrode active material occurs, which leads to the deterioration in the lifespan of the battery.

In order to solve the above problem, a method of avoiding the problem by using only the capacity at a discharge potential of less than 0.5 V without using all of the discharge capacity of the negative electrode including silicon is used. The above technique may be applied at a low charge rate. However, the discharge potential of the negative electrode may be higher than 0.5 V at a high charge rate.

In addition, when the technique is used, the average discharge potential may be controlled to satisfy less than 0.5 V for the entire negative electrode. However, the negative electrode discharge potential may be 0.5 V or higher in ‘a region adjacent to the negative electrode surface (region adjacent to the separator)’ in which the electrochemical reaction is fast, and the negative electrode discharge potential of ‘a region adjacent to the current collector’ of the negative electrode may be 0.5 V or lower. Accordingly, the phase separation of the silicon rapidly occurs in a region close to the surface of the negative electrode, so that battery lifespan may be deteriorated.

Therefore, even when the negative electrode discharge potential of 0.5 V or higher occurs in a region close to the surface of the negative electrode, a technique capable of suppressing the deterioration in the life of the battery is required.

### DISCLOSURE OF THE INVENTION

### Technical Problem

An aspect of the present invention is to provide a negative electrode capable of suppressing the deterioration in the lifespan of a battery even when a negative electrode discharge potential of 0.5 V or higher is generated in a region close to the surface of the negative electrode.

### Technical Solution

According to an aspect of the present invention, there is provided a negative electrode including a current collector and a negative electrode active material layer disposed on the current collector, wherein the negative electrode active material layer includes a negative electrode active material including SiOₓ (0≤x<2) particles, a conductive material, and a binder, and the negative electrode active material layer includes a lower layer in contact with the current collector, an upper layer positioned on the lower layer, and an intermediate layer positioned between the lower layer and the upper layer, and the total content of the conductive material and the binder in the upper layer is greater than the total content of the conductive material and the binder in the intermediate layer, and the total content of the conductive material and the binder in the lower layer is less than the total content of the conductive material and the binder in the intermediate layer.

According to another aspect of the present invention, there According to another aspect of the present invention, there is provided a secondary battery including the negative electrode, a positive electrode, and a separator interposed between the positive electrode and the negative electrode, and an electrolyte.

### Advantageous Effects

A negative electrode according to the present invention includes a negative electrode active material layer including a lower layer, an intermediate layer, and an upper layer. Since the content of a negative electrode active material of the upper layer is relatively small, even when a negative electrode discharge potential of 0.5 V or higher occurs in the upper layer, the amount of the SiOₓ (0≤x<2) particles in which phase separation occurs is not large. Furthermore, since the content of the negative electrode active material of the upper layer that primarily reacts with the electrolyte is relatively small, the degree of volume expansion may be reduced. Therefore, the deterioration in the lifespan of a battery may be suppressed by the upper layer. In addition, since the total content of the conductive material and the binder in the lower layer is relatively small, the lower layer may include a relatively large content of the negative electrode active material. Since the lower layer is in contact with the current collector and is a region located farthest from the surface of the negative electrode, the negative electrode discharge potential may be less than 0.5 V. Therefore, the phase separation of SiOₓ (0≤x<2) particles included in a high content in the lower layer may be prevented, so that the capacity and lifespan properties of a battery may be improved.

### BRIEF DESCRIPTION OF THE DRAWINGS

FIG. 1 is a graph showing the capacity per cycle of a secondary battery using each of the negative electrodes of Examples 1 to 4 and Comparative Example 1.

### MODE FOR CARRYING OUT THE INVENTION

Hereinafter, the present invention will be described in more detail to facilitate understanding of the present invention.

It will be understood that words or terms used in the specification and claims shall not be interpreted as having the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

The terminology used herein is for the purpose of describing particular exemplary embodiments only and is not intended to be limiting of the present invention. The terms of a singular form may include plural forms unless the context clearly indicates otherwise.

In the present specification, it will be further understood that the terms “include,” “comprise,” or “have” when used in this specification, specify the presence of stated features, numbers, steps, elements, or combinations thereof, but do not preclude the presence or addition of one or more other features, numbers, steps, elements, or combinations thereof.

In the present specification, an average particle diameter (D₅₀) may be defined as a particle diameter corresponding to 50% of the volume accumulation in a particle diameter distribution curve of a particle. The average particle diameter (D₅₀) may be measured by, for example, a laser diffraction method. The laser diffraction method generally enables measurement of a particle diameter from a sub-micron region to several millimeters, so that results of high reproducibility and high resolution may be obtained.

<Negative Electrode>

A negative electrode according to an embodiment of the present invention includes a current collector and a negative electrode active material layer disposed on the current collector, wherein the negative electrode active material layer includes a negative electrode active material including SiOₓ (0≤x<2) particles, a conductive material, and a binder, and the negative electrode active material layer includes a lower layer in contact with the current collector, an upper layer positioned on the lower layer, and an intermediate layer positioned between the lower layer and the upper layer, and the total content of the conductive material and the binder in the upper layer is greater than the total content of the conductive material and the binder in the intermediate layer, and the total content of the conductive material and the binder in the lower layer is less than the total content of the conductive material and the binder in the intermediate layer.

The current collector is not particularly limited as long as it has conductivity without causing a chemical change in the battery. For example, as the current collector, copper, stainless steel, aluminum, nickel, titanium, fired carbon, or aluminum or stainless steel that is surface-treated with one of carbon, nickel, titanium, silver, and the like may be used. Specifically, a transition metal which well adsorbs carbon such as copper and nickel well may be used as the current collector. The thickness of the current collector may be from 6 μm to 20 μm, but the thickness of the current collector is not limited thereto.

The negative electrode active material layer may be disposed on the current collector. The negative electrode active material layer may cover one surface or both surfaces of the current collector.

The negative electrode active material layer may include a negative electrode active material, a conductive material, and a binder.

The negative electrode active material may include SiOₓ (0≤x<2) particles. The SiOₓ (0≤x<2) particles have a high energy density, and thus, may improve the capacity of a battery when included in the negative electrode active material.

The SiOₓ (0≤x<2) may include Si and SiO₂. That is, the x corresponds to the number ratio of 0 with respect to Si contained in the SiOₓ (0≤x<2). When the core includes SiOₓ (0≤x<2), the discharge capacity of a secondary battery may be improved. More specifically, the SiOₓ may be Si or SiO. Preferably, the SiOₓ is Si, the Si may be amorphous or crystalline.

The average particle diameter (D₅₀) of the SiOₓ (0≤x<2) particles may be 0.05 μm to 100 μm, specifically 0.1 μm to 20 μm, and more specifically 0.5 μm to 10 μm. When the above range is satisfied, the degeneration of the SiOₓ (0≤x<2) particles due to repeated charging and discharging of a battery may be suppressed.

The conductive material is not particularly limited as long as it has conductivity without causing a chemical change in the battery. For example, graphite such as natural graphite or artificial graphite; a carbon-based material such as carbon black, acetylene black, Ketjen black, channel black, furnace black, lamp black, and thermal black; conductive fiber such as carbon fiber and metal fiber; a conductive tube such as a carbon nanotube; metal powder such as fluorocarbon powder, aluminum powder, and nickel powder; a conductive whisker such as zinc oxide and potassium titanate; a conductive metal oxide such as titanium oxide; a conductive material such as a polyphenylene derivative, and the like may be used. Any one or a mixture of two or more among the materials described above may be used.

The binder may include at least any one selected from the group consisting of a polyvinylidene fluoride-hexafluoropropylene copolymer (PVDF-co-HFP), polyvinylidenefluoride, polyacrylonitrile, polymethylmethacrylate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polyacrylic acid, an ethylene-propylene-diene monomer (EPDM), a sulfonated EPDM, styrene-butadiene rubber (SBR), fluorine rubber, poly acrylic acid, materials having the hydrogen thereof substituted with Li, Na, or Ca, and the like, and a combination thereof. In addition, the binder may include various copolymers thereof.

The negative electrode active material layer may include a lower layer, an intermediate layer, and an upper layer. The lower layer, the intermediate layer, and the upper layer each include the SiOₓ (0≤x<2) particles, the conductive material, and the binder.

In the negative electrode active material layer, the weight ratio of the conductive material and the binder may be 1:1.18 to 1:4, specifically 1:1.18 to 1:3. When the above range is satisfied, the adhesion force of the negative electrode active material and the conductive material may be maintained while the conductive path is maintained, so that the capacity retention rate may be further improved. The weight ratio may be satisfied in all of the upper layer, the intermediate layer, and the lower layer.

The lower layer is disposed on the current collector, and specifically, may come in contact with the current collector. The upper layer may be positioned on the lower layer. The upper layer includes the surface of the negative electrode active material layer. The intermediate layer may be positioned between the lower layer and the upper layer. That is, the intermediate layer may be positioned on the lower layer, and the upper layer may be positioned on the intermediate layer.

In other words, in a direction from the current collector toward the surface of the negative electrode active material layer, the lower layer, the intermediate layer, and the upper layer may be sequentially stacked.

The total content of the conductive material and the binder in the upper layer may be greater than the total content of the conductive material and the binder in the intermediate layer.

SiOₓ (0≤x<2) particles included in the negative electrode active material layer have a problem in that the volume thereof is excessively expanded due to electrolyte impregnation during charge and discharge. In addition, in the case in which the negative electrode discharge potential in the secondary battery becomes higher than 0.5 V, the structure of the SiOₓ (0≤x<2) particles in the negative electrode in which lithium is intercalated is changed into a structure (phase separation) in which two separated phases of Li₁₂Si₇ and Si exist. Accordingly, excessive stress is generated at the interface of the two phases so that the pulverization of the negative electrode active material occurs, which leads to the deterioration in the lifespan of the battery.

In order to solve the above problem, a method of avoiding the problem by using only the capacity at a discharge potential of less than 0.5 V without using all of the discharge capacity of the negative electrode including SiOₓ (0≤x<2) particles is used. The above technique may be applied at a low charge rate. However, the discharge potential of the negative electrode may be higher than 0.5 V at a high charge rate. In addition, when the technique is used, the average discharge potential may be controlled to be 0.5 V for the entire negative electrode. However, the negative electrode discharge potential may be 0.5 V or higher in a region adjacent to the negative electrode surface (region adjacent to the separator) in which the electrochemical reaction is fast, and the negative electrode discharge potential of a region adjacent to the current collector of the negative electrode may be 0.5 V or lower. Accordingly, the phase separation of the SiOₓ (0≤x<2) particles rapidly occurs in a region close to the surface of the negative electrode, so that battery lifespan may be deteriorated.

In order to solve the above problem, the total content of the conductive material and the binder in the upper layer may be greater than the total content of the conductive material and the binder in the intermediate layer. Accordingly, even when the volume expansion of the SiOₓ (0≤x<2) particles occurs during charge and discharge, due to the relatively large content of the conductive material and the binder, the stress may be greatly applied to the SiOₓ (0≤x<2) particles so that the volume expansion may be suppressed.

In addition, when the total content of the conductive material and the binder in the upper layer is large, the content of the negative electrode active material in the upper layer is relatively reduced. Accordingly, even when a negative electrode discharge potential of 0.5 V or higher occurs in the upper layer, the amount of the SiOₓ (0≤x<2) particles in which phase separation occurs is not large. Furthermore, since the content of the negative electrode active material of the upper layer that primarily reacts with the electrolyte is relatively small, the degree of volume expansion may be reduced. Therefore, the deterioration in the lifespan of a battery may be suppressed by the upper layer.

The total content of the conductive material and the binder in the upper layer may be 1.1 times to 3 times the total content of the conductive material and the binder in the intermediate layer, specifically 1.1 times to 2 times, more specifically 1.1 times to 1.3 times, and preferably 1.2 times to 1.3 times. When the above range is satisfied, the above-mentioned effect of suppressing the deterioration of the lifespan of a battery may be further improved.

The total content of the conductive material and the binder in the lower layer is less than the total content of the conductive material and the binder in the intermediate layer.

Since the total content of the conductive material and the binder in the lower layer is relatively small, the lower layer may include the negative electrode active material in a relatively large content. Since the lower layer is in contact with the current collector and is a region located farthest from the negative electrode surface, the negative electrode discharge potential may be less than 0.5 V. Therefore, the phase separation of SiOₓ (0≤x<2) particles included in a high content in the lower layer may be prevented, so that the capacity and lifespan properties of a battery may be improved.

The total content of the conductive material and the binder in the lower layer may be 0.1 times to 0.9 times the total content of the conductive material and the binder in the intermediate layer, specifically 0.7 times to 0.9 times, and more specifically 0.7 times to 0.8 times. When the above range is satisfied, the above-mentioned capacity and lifespan effect of a battery may be further improved.

The ratio of the thickness of the upper layer, the thickness of the intermediate layer, and the thickness of the lower layer may be from 1 to 5:2 to 8:1 to 4, and more specifically 3 to 4:2 to 4:3 to 4. When the above range is satisfied, the resistance increase of the negative electrode may be reduced to a minimum, and the capacity and lifespan effect of a battery may be improved.

A secondary battery according to another embodiment of the present invention may include a negative electrode, a positive electrode, a separator interposed between the positive electrode and the negative electrode, and an electrolyte. The negative electrode is the same as the negative electrode described above. Since the negative electrode has been described above, the detailed description thereof will be omitted.

The positive electrode may include a positive electrode current collector, and a positive electrode active material layer formed on the positive electrode current collector and including the positive electrode active material.

In the positive electrode, the positive electrode current collector is not particularly limited as long as it has conductivity without causing a chemical change in the battery. For example, stainless steel, aluminum, nickel, titanium, fired carbon, or aluminum or stainless steel that is surface-treated with one of carbon, nickel, titanium, silver, and the like may be used. Also, the positive electrode current collector may typically have a thickness of 3 μm to 500 μm, and microscopic irregularities may be prepared on the surface of the positive electrode current collector to improve the adhesion of the positive electrode active material. For example, the positive electrode current collector may be used in various forms such as a film, a sheet, a foil, a net, a porous body, a foam, a non-woven body, and the like.

The positive electrode active material may be a positive electrode active material commonly used in the art. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide such as Li_{1+c1}Mn_{2-c1}O₄ (0≤c≤0.33), LiMnO₃, LiMn₂O₃, and LiMnO₂; lithium copper oxide (Li₂CuO₂); a vanadium oxide such as LiV₃O₈, V₂O₅, and Cu₂V₂O₇; a Ni-site type lithium nickel oxide represented by the formula LiNi_{1-c2}M_{c2}O₂ (wherein M is any one of Co, Mn, Al, Cu, Fe, Mg, B or Ga, and 0.01≤c2≤0.3); a lithium manganese composite oxide represented by the formula LiMn_{2-c3}M_{c3}O₂ (wherein, M is any one of Co, Ni, Fe, Cr, Zn, or Ta, and 00.01≤c3≤0.1), or by the formula Li₂Mn₃MO₈ (wherein, M is any one of Fe, Co, Ni, Cu, or Zn); LiMn₂O₄ having a part of Li in the formula substituted with an alkaline earth metal ion, and the like, but is not limited thereto. The positive electrode may be a Li-metal.

The positive electrode active material layer may include a positive electrode conductive material and a positive electrode binder, together with the positive electrode active material described above.

At this time, the positive electrode conductive material is used to impart conductivity to an electrode, and any positive electrode conductive material may be used without particular limitation as long as it has electronic conductivity without causing a chemical change in a battery to be constituted. Specific examples thereof may include graphite such as natural graphite or artificial graphite; a carbon-based material such as carbon black, acetylene black, Ketjen black, channel black, furnace black, lamp black, thermal black, and carbon fiber; metal powder or metal fiber of such as copper, nickel, aluminum, and silver; a conductive whisker such as a zinc oxide whisker and a potassium titanate whisker; a conductive metal oxide such as titanium oxide; or a conductive polymer such as a polyphenylene derivative, and any one thereof or a mixture of two or more thereof may be used.

In addition, the positive electrode binder serves to improve the bonding between positive electrode active material particles and the adhesion between the positive electrode active material and the positive electrode current collector. Specific examples thereof may include polyvinylidene fluoride (PVDF), a polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene monomer (EPDM), a sulfonated EPDM, styrene-butadiene rubber (SBR), fluorine rubber, or various copolymers thereof, and any one thereof or a mixture of two or more thereof may be used.

The separator is to separate the negative electrode and the positive electrode and to provide a movement path for lithium ions. Any separator may be used without particular limitation as long as it is a separator commonly used in a secondary battery. Particularly, a separator having excellent moisture-retention of an electrolyte as well as low resistance to ion movement in the electrolyte is preferable. Specifically, a porous polymer film, for example, a porous polymer film manufactured using a polyolefin-based polymer such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous non-woven fabric, for example, a non-woven fabric formed of glass fiber having a high melting point, or polyethylene terephthalate fiber, and the like may be used as the separator. Furthermore, a coated separator including a ceramic component or a polymer material may be used to secure heat resistance or mechanical strength, and may be used in a single-layered or a multi-layered structure, selectively.

The electrolyte may be an organic liquid electrolyte, an inorganic liquid electrolyte, a solid polymer electrolyte, a gel-type polymer electrolyte, a solid inorganic electrolyte, a molten-type inorganic electrolyte, and the like, which may be used in the preparation of a lithium secondary battery, but is not limited thereto.

Specifically, the electrolyte may include a non-aqueous organic solvent and a lithium salt.

As the non-aqueous organic solvent, for example, a non-quantum organic solvent, such as N-methyl-2-pyrrolidone, propylene carbonate, ethylene carbonate, butylene carbonate, dimethyl carbonate, diethyl carbonate, γ-butyrolactone, 1,2-dimethoxy ethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate may be used.

In particular, among the carbonate-based organic solvents, cyclic carbonates ethylene carbonate and propylene carbonate may be preferably used since they are organic solvents of a high viscosity having high permittivity to dissociate a lithium salt well. Furthermore, such a cyclic carbonate may be more preferably used since the cyclic carbonate may be mixed with a linear carbonate of a low viscosity and low permittivity such as dimethyl carbonate and diethyl carbonate in an appropriate ratio to prepare an electrolyte having a high electric conductivity.

As the metal salt, a lithium salt may be used. The lithium salt is a material which is easily dissolved in the non-aqueous electrolyte. For example, as an anion of the lithium salt, one or more selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻ may be used.

In the electrolyte, in order to improve the lifespan characteristics of a battery, to suppress the decrease in battery capacity, and to improve the discharge capacity of the battery, one or more additives, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, and the like may be further included other than the above electrolyte components.

According to yet another embodiment of the present invention, a battery module including the secondary battery as a unit cell, and a battery pack including the same are provided. The battery module and the battery pack include the secondary battery which has high capacity, high rate properties, and cycle properties, and thus, may be used as a power source of a medium-and-large sized device selected from the group consisting of an electric car, a hybrid electric vehicle, a plug-in hybrid electric vehicle, and a power storage system.

Hereinafter, preferred embodiments of the present invention will be described in detail to facilitate understanding of the present invention. However, the embodiments are merely illustrative of the present invention, and thus, it will be apparent to those skilled in the art that various modifications and variations can be made without departing from the scope and spirit of the present invention as disclosed in the accompanying claims. It is obvious that such variations and modifications fall within the scope of the appended claims.

### EXAMPLES AND COMPARATIVE EXAMPLE

### Example 1: Manufacturing of Negative Electrode

(1) Manufacturing of Negative Electrode

Si particles having an average particle diameter (D₅₀) of 5 μm was used as a negative electrode active material, a graphite-based conductive material of artificial graphite series was used as a conductive material, and polyimide having a weight average molecular weight of 1,200,000 g/mol was used as a binder.

1) Forming of Lower Layer

The negative electrode active material, the conductive material, and the binder were mixed at a weight ratio of 77.5:7.5:15 to prepare 10 g of a mixture. The mixture was added with 3 g of deionized water which is a solvent and then stirred to prepare a first negative electrode slurry.

The first negative electrode slurry was applied on a copper (Cu) metal thin film having a thickness of 20 μm, which is a negative electrode current collector, and then dried. At this time, the temperature of circulated air was 60° C. Through the above, a lower layer having a thickness of 8 μm was formed on the negative electrode current collector.

2) Forming of Intermediate Layer

The negative electrode active material, the conductive material, and the binder were mixed at a weight ratio of 70:10:20 to prepare 10 g of a mixture. The mixture was added with 3 g of deionized water which is a solvent and then stirred to prepare a second negative electrode slurry.

The second negative electrode slurry was applied on the lower layer and then dried. At this time, the temperature of circulated air was 60° C. Through the above, an intermediate layer having a thickness of 8 μm was formed on the lower layer.

3) Forming of Upper Layer

The negative electrode active material, the conductive material, and the binder were mixed at a weight ratio of 62.5:12.5:25 to prepare 10 g of a mixture. The mixture was added with 3 g of deionized water which is a solvent and then stirred to prepare a third negative electrode slurry.

The third negative electrode slurry was applied on the intermediate layer, and then dried. At this time, the temperature of circulated air was 60° C. Through the above, an upper layer having a thickness of 8 μm was formed on the intermediate layer.

4) Forming of Negative Electrode

The current collector in which the lower layer, the intermediate layer, and the upper layer were sequentially disposed was dried in a vacuum oven at 130° C. for 12 hours, and punched into a circular shape of 1.4875 cm² to prepare a negative electrode.

### Examples 2 to 4 and Comparative Example 1: Manufacturing of Negative Electrode

The current collector in which the lower layer, the intermediate layer, and the upper layer were sequentially disposed was dried in a vacuum oven at 130° C. for 12 hours, and punched into a circular shape of 1.4875 cm² to prepare a negative electrode.

A negative electrode was manufactured in the same manner as in Example 1 except that the weight ratio of the negative electrode active material, the conductive material, and the binder was adjusted in each of the upper layer, the intermediate layer, and the lower layer.

TABLE 1

| | Weight | Weight | Weight | | |
|---|---|---|---|---|---|
| | ratio in | ratio in | ratio in | | |
| | upper | intermediate | lower | | |
| | layer | layer | layer | | |
| | (A:B:C) | (A:B:C) | (A:B:C) | x/y | z/y |
| Example 1 | 62.5:12.5:25 | 70:10:20 | 77.5:7.5:15 | 1.25 | 0.75 |
| Example 2 | 55:15:30 | 70:10:20 | 85:5:10 | 1.5 | 0.50 |
| Example 3 | 67:11:22 | 70:10:20 | 73:9:18 | 1.1 | 0.90 |
| Example 4 | 62.5:17.5:20 | 70:10:20 | 77.5:2.5:20 | 1.25 | 0.75 |
| Comparative | 70:10:20 | 70:10:20 | 70:10:20 | 1 | 1 |
| Example 1 | | | | | |

In Table 1, A is a negative electrode active material, B is a conductive material, C is a binder, and x/y and z/y are as follows.

x/y=Total content of conductive material and binder in upper layer/total content of conductive material and binder in intermediate layer

z/y=Total content of conductive material and binder in lower layer/total content of conductive material and binder in intermediate layer

### Experimental Example 1: Evaluation of Cycle Properties of Secondary Battery

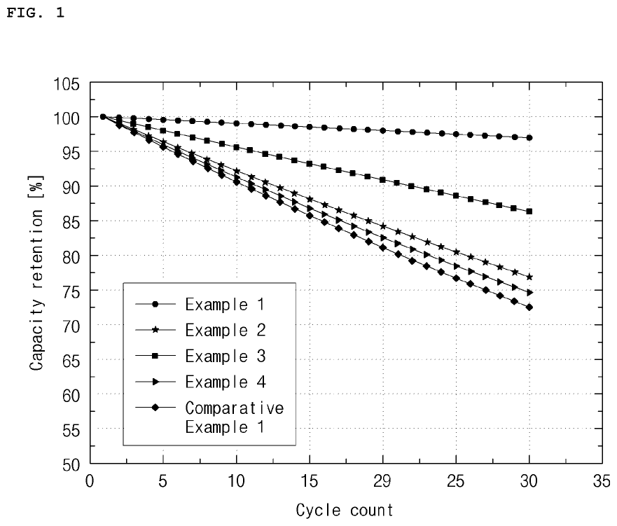

The cycle properties of a secondary battery using the negative electrode of each of Examples 1 to 4 and Comparative Examples 1 and 2 were evaluated as follows, and are shown in FIG. 1.

As the positive electrode active material, Li[Ni_{0.6}Mn_{0.2}Co_{0.2}]O₂ was used. The positive electrode active material, carbon black which is a conductive material, polyvinylidene fluoride (PVDF) which is a binder were mixed at a weight ratio of 94:4:2 to N-methyl-2-pyrrolidone (NMP) which is a solvent to prepare a positive electrode slurry.

The prepared positive electrode slurry was applied on an aluminum metal thin film having a thickness of 15 μm, which is a positive electrode current collector, and then dried. At this time, the temperature of the air circulated was 110° C. Thereafter, the aluminum metal thin film applied with the positive electrode slurry and then dried was roll-pressed, and then dried in a vacuum oven at 130° C. for 2 hours to prepare a positive electrode active material layer.

The negative electrode of each of Examples 1 to 4 and Comparative Examples 1 and 2, the manufactured positive electrode, and a porous polyethylene separator were assembled using a stacking method, and the assembled battery was injected with an electrolyte (ethylene carbonate (EC)/ethyl methyl carbonate (EMC)=½ (volume ratio), lithium hexa fluoro phosphate (1 mole of LiPF₆) to manufacture a lithium secondary battery.

Each of the lithium secondary batteries were subjected to charge discharge under the following conditions.

Charge condition: charged to 4.2 V at 0.5 C constant current, and then charged to 4.2 V until 0.1 C current rate flowed

Discharge condition: discharged to 3.4 V at 0.5 C current rate

1. A negative electrode comprising:
a current collector; and
a negative electrode active material layer disposed on the current collector, wherein
the negative electrode active material layer includes a negative electrode active material including SiOₓ (0≤x<2) particles, a conductive material, and a binder,
the negative electrode active material layer includes a lower layer in contact with the current collector, an upper layer positioned on the lower layer, and an intermediate layer positioned between the lower layer and the upper layer,
a total content of the conductive material and the binder in the upper layer is greater than a total content of the conductive material and the binder in the intermediate layer, and
a total content of the conductive material and the binder in the lower layer is less than the total content of the conductive material and the binder in the intermediate layer.

2. The negative electrode of claim 1, wherein the total content of the conductive material and the binder in the upper layer is 1.1 times to 3 times the total content of the conductive material and the binder in the intermediate layer.

3. The negative electrode of claim 1, wherein the total content of the conductive material and the binder in the upper layer is 1.2 times to 1.3 times the total content of the conductive material and the binder in the intermediate layer.

4. The negative electrode of claim 1, wherein the total content of the conductive material and the binder in the lower layer is 0.1 times to 0.9 times the total content of the conductive material and the binder in the intermediate layer.

5. The negative electrode of claim 1, wherein the total content of the conductive material and the binder in the lower layer is 0.7 times to 0.8 times the total content of the conductive material and the binder in the intermediate layer.

6. The negative electrode of claim 1, wherein a ratio of a thickness of the upper layer, a thickness of the intermediate layer, and a thickness of the lower layer is 1 to 5:2 to 8:1 to 4.

7. The negative electrode of claim 1, wherein in the negative electrode active material layer, a weight ratio of the conductive material and the binder is 1:1.18 to 1:4.

8. The negative electrode of claim 1, wherein an average particle diameter (D₅₀) of the SiOₓ (0≤x<2) particles is 0.05 μm to 100 μm.

9. The negative electrode of claim 1, wherein the SiOₓ (0≤x<2) particle is Si.

10. A secondary battery comprising the negative electrode of claim 1, a positive electrode, a separator interposed between the positive electrode and the negative electrode, and an electrolyte.
